(19) United States
(12) Patent Application Publication
(10) Pub. No.: US 2006/0033775 A1
(43) Pub. Date: Feb. 16, 2006

(54) Image processing apparatus having flat flexible cable with adjusted configuration

(75) Inventors: Yi-Yuan Tsai, Taipei (TW); Hsi-Yu Chen, Taipei (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/129,599

(22) Filed: May 13, 2005

(30) Foreign Application Priority Data
Aug. 11, 2004 (TW) 093124115

(51) Int. Cl. B41J 2/14

(52) U.S. Cl. 347/50

(57) ABSTRACT

An image processing apparatus having a flat flexible cable with adjusted configuration for obtaining digital image data of an object is provided. The image processing apparatus includes: a casing; a carriage module disposed in the casing and movable relative to the object for picking up and converting image of the object into the digital image data; a flat flexible cable having a first end fixed at a certain location of the casing and a second end coupled to and movable with the carriage module for transmitting the digital image data from the carriage module; and a cable-adjusting device coupled to and movable with the flat flexible cable when the second end of the flat flexible cable moves with the carriage module, and having a length varying with a configuration of the flat flexible cable so as to keep stretching the flat flexible cable.

### FIELD OF THE INVENTION

The present invention relates to an image processing apparatus, and more particularly to a flatbed image scanner having a flat flexible cable with adjusted configuration.

### BACKGROUND OF THE INVENTION

In modern ages, digital information transmission is applied to more and more fields since computers and network systems become available everywhere. One of the applications is for image input/output. An image scanner is popular for processing image in a digital manner so as to be widely used at home or offices nowadays.

Please refer to FIG. 1 which is a perspective diagram showing a conventional flatbed image scanner 10. The conventional flatbed image scanner 10 includes a carriage module 11, a conveyer belt 12 moving around a pulley 13 and driven by a motor 15, a track 14 penetrating through the carriage module 11, a scanning platform 16 made of transparent glass, and a flat flexible cable (FFC) 17 with one end connected to the carriage module 11 and the other end connected to a circuit board 18 and bent or stretched with the movement of the carriage module 11. Before scanning, an object 21 to be scanned such as a document or a picture is placed on the scanning platform 16. Then, the motor 15 starts up and drives the conveyer belt 12 to loop around the pulley 13 to start the scanning procedure. The carriage module 11 fixed to and carried by a portion of the conveyer belt 12 is driven to move along the track 14 to pass by and scan the object 21 placed on the scanning platform 16 and obtains image data of the object 21. Then, the carriage module 11 converts the image data into digital image data and transmits them to the circuit board 18 via the flat flexible cable 17. At last, the digital image data is outputted to a computer 19 via a signal cable 20, e.g. a universal serial bus (USB) cable or an IEEE 1394 bus cable, connecting between the computer 19 and the circuit board 18 to generate an image file for further processing.

However, a problem occurs while the scanning procedure of the conventional image scanner 10 proceeds. Please refer to FIG. 2 which is a side cross view of the conventional flatbed imager scanner 10. It is basic that the carriage module 11 moving from point A should be capable of reaching point B to across the whole scanning platform 16 for scanning an object 21 with large size. Hence, the length of the flat flexible cable 17 connecting the carriage module 11 to the circuit board 18 fixed at one side on the bottom of the flatbed image scanner 10 should be long enough to support the movement of the carriage module 11, for example, exceeding the distance between point A and point B. During the movement of the carriage module 11, the flat flexible cable 17 will bend or stretch so its configuration varies all the time. When the carriage module 11 moves to the position adjacent to the circuit board 18, the bending portion of the long flat flexible cable 17 will raise to touch the scanning platform 16 at point C as shown in FIG. 3. The contact point C varies with the movement of the carriage module 11 so that a particular region of the scanning platform 16 is frequently rubbed. Plastic particles resulting from the abrasion and dropped out form the flat flexible cable 17 will adhere to and contaminate the scanning platform 16. Alternatively, the scanning platform 16 may get scrape thereon. Both the conditions adversely affect the scanning quality of the image scanner 10.

### SUMMARY OF THE INVENTION

The present invention provides an image processing apparatus having a flat flexible cable with adjusted configuration.

The present invention also provides a flatbed image scanner having a flat flexible cable with adjusted configuration, so no abrasion will occur due to the changed configuration of the flat flexible cable during the scanning procedure.

An image processing apparatus for obtaining digital image data of an object, comprises a casing; a carriage module disposed in the casing and movable relative to the object for picking up and converting image of the object into the digital image data; a flat flexible cable having a first end fixed at a certain location of the casing and a second end coupled to and movable with the carriage module for transmitting the digital image data from the carriage module; and a cable-adjusting device coupled to and movable with the flat flexible cable when the second end of the flat flexible cable moves with the carriage module, and having a length varying with a configuration of the flat flexible cable so as to keep stretching the flat flexible cable.

According to an embodiment of the present invention, the image processing apparatus further comprises a transport mechanism which includes: a motor; a track extending along a moving direction of the carriage module and penetrating through the carriage module to allow the carriage module to slide therealong; a roller disposed at one end of a moving path of the carriage module; and a conveyer belt fixing thereto the carriage module and driven by the motor to move around the roller so as to transmit the carriage module to move along the track.

According to the embodiment of the present invention, the flat flexible cable bends at different positions with the movement of the carriage module, and the cable-adjusting device differentially stretches the flat flexible cable at the bending positions.

For example, the cable-adjusting device comprises a ring member penetrating therethrough the flat flexible cable and differentially stretching the flat flexible cable at the bending positions when the flat flexible cable moves thereinside.

In an embodiment, the cable-adjusting device further comprises: a rope with one end fixed to the ring member; a reel concentrically mounted on and rotating with the roller for reeling in the rope to pull the ring member when the carriage module moves toward the reel and reeling off the rope to release the ring member when the carriage module moves away from the reel; and a static pulley forming an orthogonal triangle with the ring member and the reel for keeping the flat flexible cable straight and stretching the rope. Preferably, the radius of the reel is half of the radius of the roller.

In an alternative embodiment, the cable-adjusting device further comprises: a spring member with a first end fixed to the casing and a second end catching on the ring member; and a rope connecting the spring member to the ring member. In practice, the spring member deforms when the carriage module moves away from the first end of the spring member and recovers to pull the ring member when the carriage module moves toward the first end of said spring member.

In an alternative embodiment, the cable-adjusting device further comprises: a rope with one end connected to the ring member; and an automatic reel fixed to the casing and coupled to the rope. The automatic reel reels off the rope to have the ring member move when the carriage module moves away therefrom, and automatically reels in the rope to pull the ring member when the carriage module is coming closer.

According to the present invention, the flatbed image scanner includes a casing having an opening; a scanning platform lodged in the opening for supporting thereon an object to be scanned; a carriage module disposed and movable under the scanning platform in the casing for scanning the object to obtain digital image data of the object; a circuit board electrically connected to the carriage module via a flat flexible cable that transmits the digital image data; and a cable-adjusting device mounted in the casing and coupling to the flat flexible cable in a relatively movable manner for stretching the flat flexible cable in a specific direction to adjust the configuration of the flat flexible cable, thereby avoiding the contact between the flat flexible cable and the scanning platform.

In an embodiment, the circuit board is electrically connected to a digital processing system for processing the digital image data via a port arranged on the casing and a signal cable with one end connecting to the digital processing system.

According to the embodiment of the present invention, the flatbed image scanner further comprises a transport mechanism which includes: a motor; a track allowing the carriage module to slide therealong; a roller disposed at one end of a moving path of the carriage module; and a conveyer for transmitting the carriage module to move along the track.

### BRIEF DESCRIPTION OF THE DRAWINGS

The present invention may best be understood through the following description with reference to the accompanying drawings, in which:

FIG. 1 is perspective diagram showing a conventional flatbed image scanner;

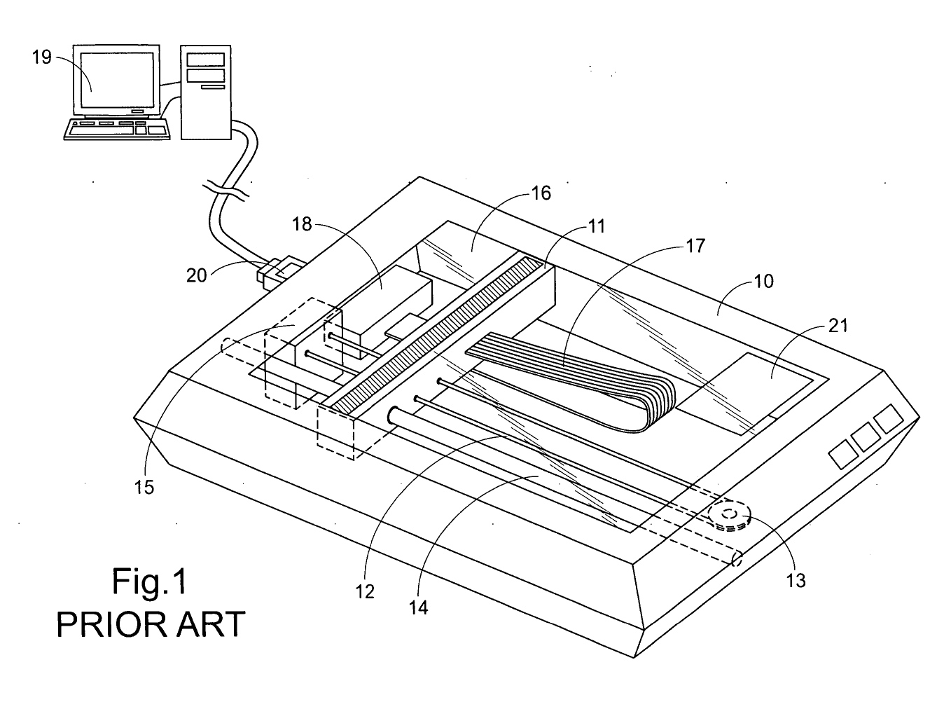

FIG. 2 is a side cross view of the conventional flatbed imager scanner of FIG. 1;

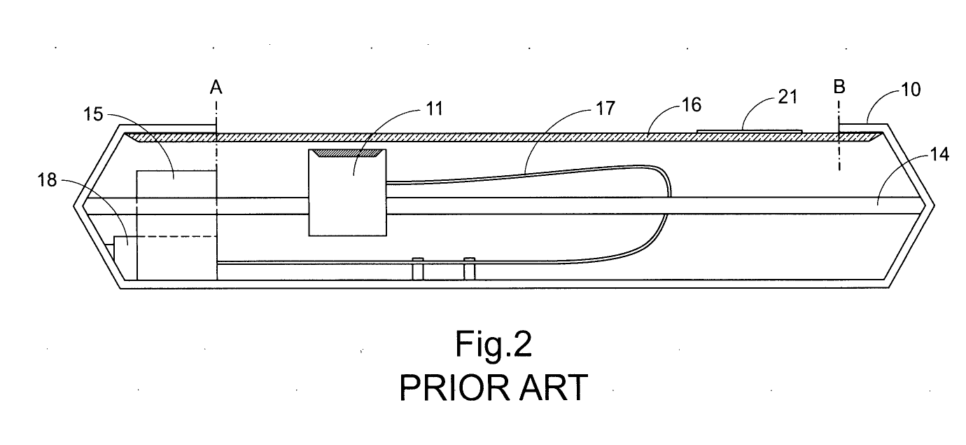

FIG. 3 is a partial side cross view of the conventional flatbed image scanner schematically showing the contact occurring between the flat flexible cable 17 and the scanning platform 16;

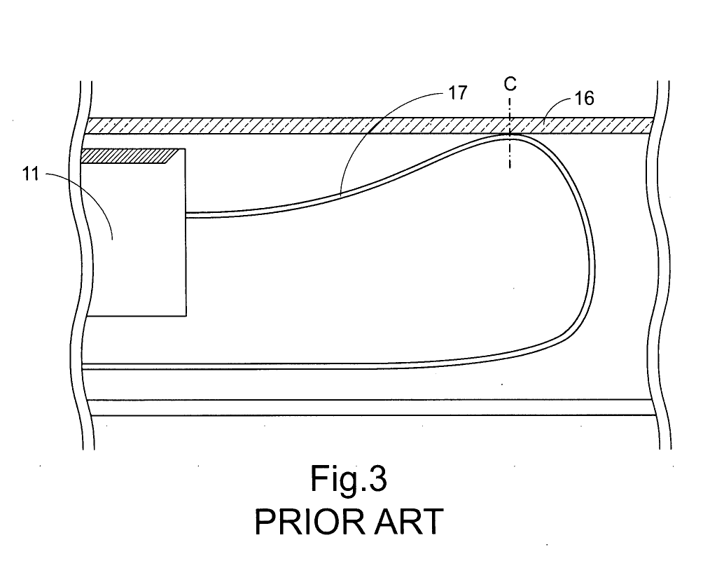

FIG. 4 is a perspective diagram showing a preferred embodiment of a flatbed image scanner according to the present invention;

FIG. 5 is a perspective diagram showing another preferred embodiment of a flatbed image scanner according to the present invention; and

FIG. 6 is a perspective diagram showing a further preferred embodiment of a flatbed image scanner according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

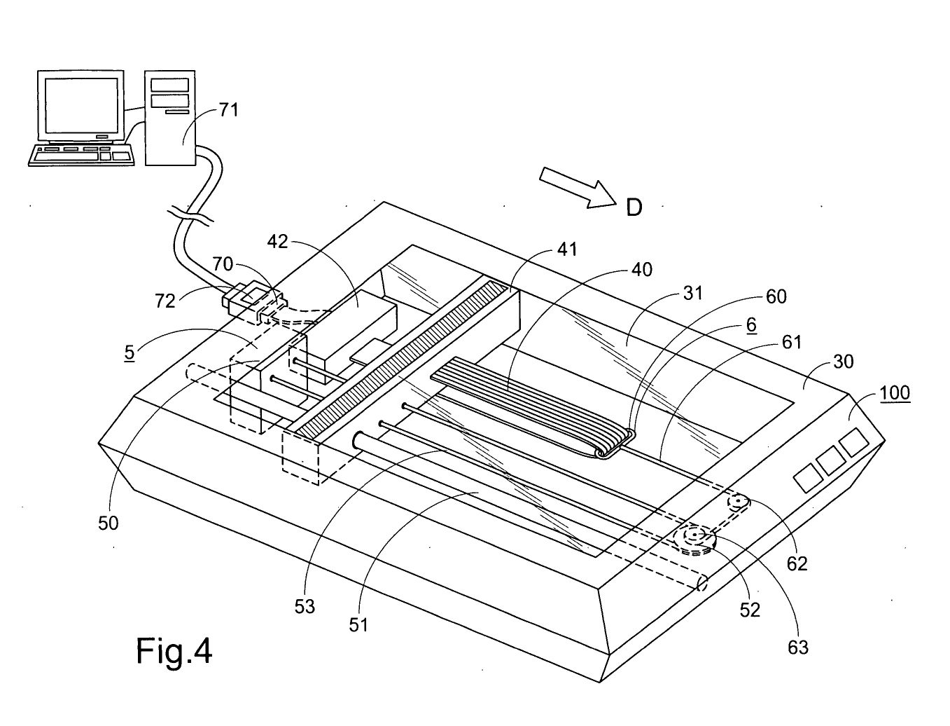

Please refer to FIG. 4 is a perspective diagram showing a preferred embodiment of a flatbed image scanner according to the present invention. The flatbed image scanner 100 includes a casing 30 having an opening at the top for a scanning platform 31 to lodge in. The scanning platform 31 is usually made of transparent glass for supporting thereon an object (not shown) to be scanned. In the casing 30, a carriage module 41, a circuit board 42, and a flat flexible cable 40 with two ends respectively connected to the carriage module 41 and the circuit board 42 are disposed. The carriage module 41 is movable under the scanning platform 31 for picking up image data of the object placed on the scanning platform 31, and then converting the image data into digital image data. The flat flexible cable 40 bends at different positions with the movement of the carriage module 41 to accommodate the changed position of the carriage module 41 while scanning. The function of the flat flexible cable 40 is to transmit the digital image data form the carriage module 41 to the circuit board 42. Then, the digital image data are transmitted to a digital processing system 71, e.g. a computer, for further processing via a port 70 arranged on the casing 30 and a signal cable 72 with one end connected to the digital processing system 71. In practice, control signals can be transmitted from the circuit board 42 to the carriage module 41 via the flat flexible cable 40 to achieve bidirectional transmission.

A transport mechanism 5 including a motor 50, a track 51, a roller, 52, and a conveyer belt 53 is also provided in the casing 30 for transmitting the carriage module 41 to move in a direction conforming to or contrary to the direction D. The motor 50 drives the conveyer belt 53 to move around the roller 52 disposed at one end of a moving path of the carriage module 41 and rotating with the drag of the conveyer belt 53. Hence, the carriage module 41 fixed to the conveyer belt 53 is driven to slide along the track 51 extending along the moving direction of the carriage module 41 and penetrating through the carriage module 41.

The present invention provides a characteristic cable-adjusting device 6 disposed in the casing 30 and coupled to the flat flexible cable 40 in a relatively movable manner for stretching the flat flexible cable 40 in direction D as shown by an arrow in the diagram so as to adjust the configuration of the flat flexible cable 40. In this embodiment, the cable-adjusting device 6 includes a ring member 60 penetrated by the bending portion of the flat flexible cable 40, a reel 63 concentrically mounted on and rotating with the roller 52, a static pulley 62 mounted at one end of the casing 30, and a rope 61 having one end coupled to the ring member 60 and the other end is reeled in the reel 63 and sliding over the static pulley 62. The positions of the ring member 60, the static pulley 62, and the reel 63 form an orthogonal triangle wherein the right angle of the orthogonal triangle is formed at the position of the static pulley 62. The static pulley 62 is used for changing the direction for stretching the flat flexible cable 40. Hence, the cable-adjusting device 6 can include more than one static pulley if necessary. The location of the static pulley 62 can varied with the arrangement of the cable-adjusting device 6. In a preferred embodiment, the radius of the reel 63 is about half of the radius of the roller 52.

When the carriage module 41 moves toward circuit board 42 (in a reverse direction of direction D), the bending portion of the flat flexible cable 40 will move toward the circuit board 42, too. The roller 52 and the reel 63 concentrically mounted on the roller 52 rotate counterclockwise so the reel 63 reels off the rope 61. Please be advised that the specific direction such as clockwise or counterclockwise described in the specification may be modified according to the arrangement of the elements and components in the image scanner 100. Since the radius of the reel 63 is about half of the radius of the roller 52, the moving distance of the ring member 60 ringing the bending portion of the flat flexible cable 40 will be shorter than the moving distance of the carriage module 41. Hence, the rope 61 and the ring member 60 can pull the bending portion of the flat flexible cable 40 to keep it in a straight manner toward the static pulley 62. In this manner, the bending portion of the flat flexible cable 40 will not raise to touch the scanning window 31. Therefore, the abrasion problem due to the contact between the flat flexible cable 40 and the scanning window 31 is effectively overcome.

When the carriage module 41 moves in direction D, the roller 52 and the reel 63 are driven to rotate clockwise so the reel 63 reels in the rope 61. The unreeled portion of the rope 62 is shorten so as to drag the ring member 60 to move in direction D thereby stretching the flat flexible cable 40 at its bending portion. Hence, the configuration of the flat flexible cable 40 is advantageously adjusted in a straight manner to overcome the abrasion problem.

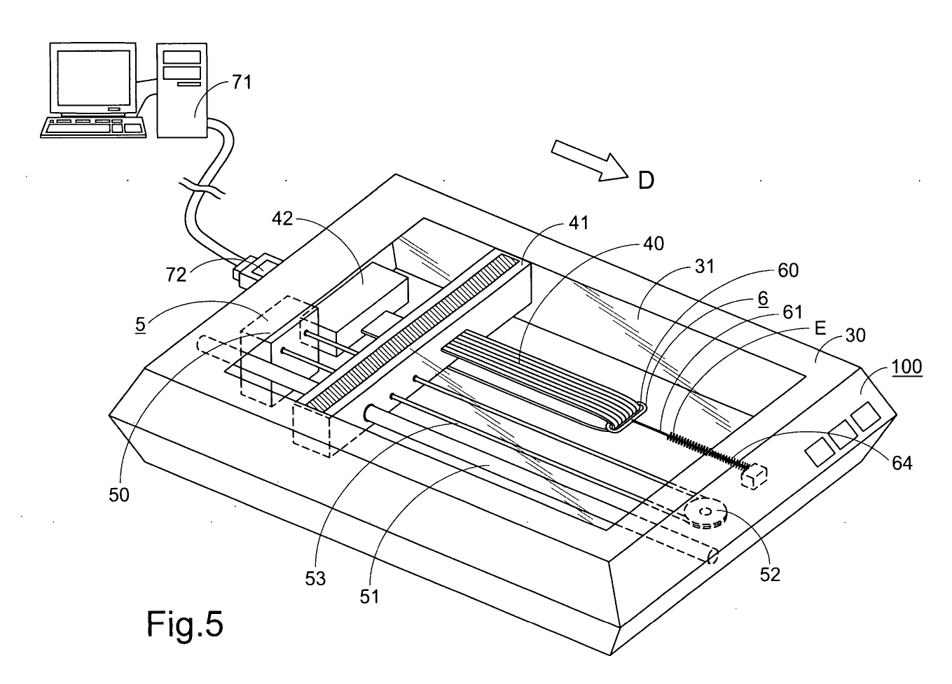

An alternative embodiment of the cable-adjusting device 6 is shown in FIG. 5 which is a perspective diagram showing a preferred embodiment of a flatbed image scanner according to the present invention. The cable-adjusting device 6 includes a ring member 60 penetrated by the bending portion of the flat flexible cable 40, a spring member 64 with one end fixed to the casing 30 at the opposite side to the circuit board 42, and a rope 61 connecting the spring member 64 to the ring member 60. When the carriage module 41 moves to the position farthest from the circuit board 42, the spring member 64 is in an equilibrium status. If the carriage module 41 departs from the “equilibrium position” to move toward the circuit board 42, the end E of the spring member 64 is pulled by the rope 61 coupled to the ring member 60 and the spring member 64 deforms. The deformed spring member 64 generates a recovery force in proportion to the deformation in order to restore the spring member 64 to its equilibrium status. Hence, the bending portion of the flat flexible cable 40 is pulled and stretched toward the spring member 64 so as to keep the configuration of the flat flexible cable 40 in a straight manner. It is important that the spring member 64 should be strong enough to bear the pull by the rope 61 and the largest deformation of the spring member 64 should be controlled in a certain range to avoid the spring fatigue.

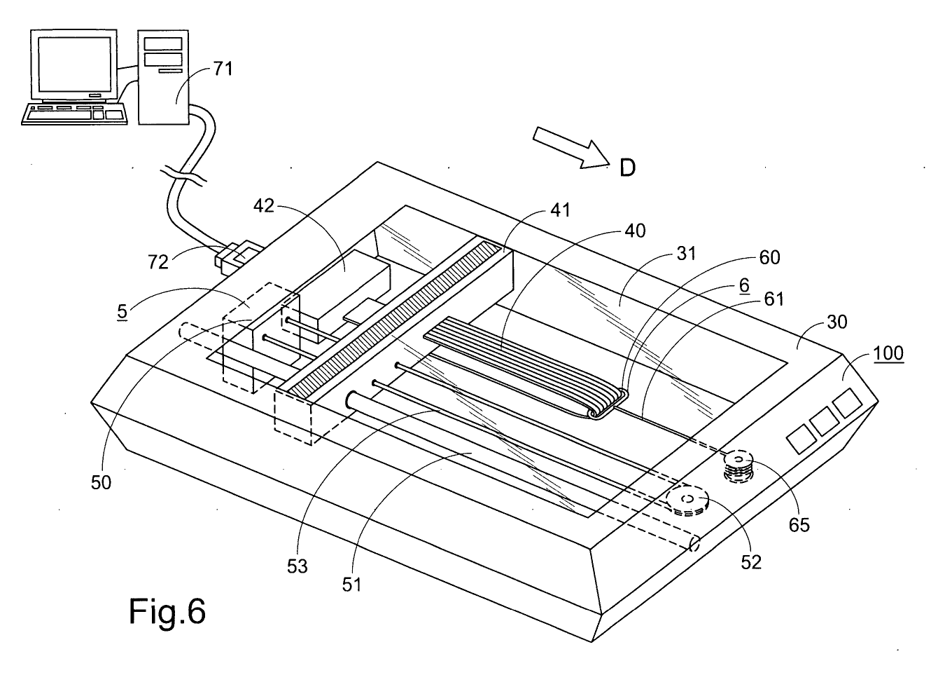

Another embodiment of the cable-adjusting device 6 is shown in FIG. 6 which is a perspective diagram showing a preferred embodiment of a flatbed image scanner according to the present invention. The cable-adjusting device 6 includes a ring member 60 penetrated by the bending portion of the flat flexible cable 40, a rope 61 with one end connected to the ring member 60, and an automatic reel 65 fixed to the casing 30 at the opposite side to the circuit board 42 and reeling in the rope 61. The structure of the automatic reel 65 is similar to a measuring tape with automatic retraction function. In other words, the automatic reel 65 has a tendency to rotate clockwise. When the carriage module 41 moves in a reverse direction of direction D, the automatic reel 65 reels off the rope 61 due to the drag by the ring member 60. However, the automatic reel 65 will try to reel in the rope 61 until the drag force by the ring member 60 coupled to the bending portion of the flat flexible cable 40 is balanced with the recovery rotating force generated by the automatic reel 65. Hence, a force is always provided automatically by the automatic reel 65 for stretching the bending portion of the flat flexible cable 40 toward the automatic reel 65 to keep the configuration of the flat flexible cable 40 in a straight manner. By this way, when the carriage module 41 is close to the circuit board 42, the bending portion of the flat flexible cable 40 will not raise to touch the scanning window 31.

The present invention can be applied to not only image scanner but also any other image processing apparatus, e.g. copier, multifunction & All-In-One, or digital sender, in which a flat flexible cable has various configurations during the image-processing procedure. As described above, the cable-adjusting device is helpful to restrict the flat flexible cable within appropriate space to overcome the problem due to its changed configurations.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image processing apparatus for obtaining digital image data of an object, comprising:
a casing;
a carriage module disposed in said casing and movable relative to said object for picking up and converting image of said object into said digital image data;
a flat flexible cable having a first end fixed at a certain location of said casing and a second end coupled to and movable with said carriage module for transmitting said digital image data from said carriage module; and
a cable-adjusting device coupled to and movable with said flat flexible cable when said second end of said flat flexible cable moves with said carriage module, and having a length varying with a configuration of said flat flexible cable so as to keep stretching said flat flexible cable.

2. The image processing apparatus according to claim 1 further comprising a transport mechanism that comprises:
a motor;
a track extending along a moving direction of said carriage module and penetrating through said carriage module to allow said carriage module to slide therealong;
a roller disposed at one end of a moving path of said carriage module; and
a conveyer belt fixing thereto said carriage module and driven by said motor to move around said roller so as to transmit said carriage module to move along said track.

3. The flatbed image scanner according to claim 1 wherein said flat flexible cable bends at different positions with the movement of said carriage module, and said cable-adjusting device differentially stretches said flat flexible cable at said bending positions.

4. The image processing apparatus according to claim 3 wherein said cable-adjusting device comprises a ring member penetrating therethrough said flat flexible cable and differentially stretching said flat flexible cable at said bending positions when said flat flexible cable moves thereinside.

5. The image processing apparatus according to claim 4 wherein said cable-adjusting device further comprises:
a rope with one end fixed to said ring member; and
a reel concentrically mounted on and rotating with said roller for reeling in said rope to pull said ring member when said carriage module moves toward said reel and reeling off said rope to release said ring member when said carriage module moves away from said reel.

6. The image processing apparatus according to claim 5 wherein said cable-adjusting device further comprises a static pulley forming an orthogonal triangle with said ring member and said reel for keeping said flat flexible cable straight and stretching said rope.

7. The image processing apparatus according to claim 4 wherein said cable-adjusting device further comprises a spring member with a first end fixed to said casing and a second end catching on said ring member, and said spring member deforms when said carriage module moves away from said first end of said spring member and recovers to pull said ring member when said carriage module moves toward said first end of said spring member.

8. The image processing apparatus according to claim 7 wherein said cable-adjusting device further comprises a rope connecting said spring member to said ring member.

9. The image processing apparatus according to claim 4 wherein said cable-adjusting device further comprises:
a rope with one end connected to said ring member; and
an automatic reel fixed to said casing and coupled to said rope, wherein said automatic reel reels off said rope to have said ring member move when said carriage module moves away therefrom and automatically reels in said rope to pull said ring member when said carriage module is coming closer.

10. A flatbed image scanner comprising:
a casing having an opening;
a scanning platform lodged in said opening for supporting thereon an object to be scanned;
a carriage module disposed and movable under said scanning platform in said casing for scanning said object to obtain digital image data of said object;
a circuit board electrically connected to said carriage module via a flat flexible cable that transmits said digital image data; and
a cable-adjusting device mounted in said casing and coupling to said flat flexible cable in a relatively movable manner for stretching said flat flexible cable in a specific direction to adjust the configuration of said flat flexible cable, thereby avoiding the contact between said flat flexible cable and said scanning platform.

11. The flatbed image scanner according to claim 10 wherein said circuit board is electrically connected to a digital processing system for processing said digital image data via a port arranged on said casing and a signal cable with one end connected to said digital processing system.

12. The flatbed image scanner according to claim 10 further comprising a transport mechanism that comprises:
a motor;
a track extending along a moving direction of said carriage module and penetrating through said carriage module to allow said carriage module to slide therealong;
a roller disposed at one end of a moving path of said carriage module; and
a conveyer belt fixing thereto said carriage module and driven by said motor to move around said roller so as to transmit said carriage module to move along said track.

13. The flatbed image scanner according to claim 10 wherein said flat flexible cable bends at different positions with the movement of said carriage module under said scanning platform, and said cable-adjusting device differentially stretches said flat flexible cable at said bending positions.

14. The flatbed image scanner according to claim 13 wherein said cable-adjusting device comprises a ring member penetrated therethrough said flat flexible cable and differentially stretching said flat flexible cable at said bending positions when said flat flexible cable moves thereinside.

15. The flatbed image scanner according to claim 14 wherein said cable-adjusting device further comprises:
a rope with one end fixed to said ring member; and
a reel concentrically mounted on and rotating with said roller for reeling in said rope to pull said ring member when said carriage module moves in a direction conforming to said specific direction for stretching said flat flexible cable and reeling off said rope to release said ring member when said carriage module moves in a direction contrary to said specific direction for stretching said flat flexible cable.

16. The flatbed image scanner according to claim 15 wherein said cable-adjusting device further comprises a static pulley forming an orthogonal triangle with said ring member and said reel for keeping said direction for stretching said flat flexible cable and further stretching said rope.

17. The flatbed image scanner according to claim 15 wherein the radius of said reel is half of the radius of said roller.

18. The flatbed image scanner according to claim 14 wherein said cable-adjusting device further comprises a spring member with one end fixed to said casing at the opposite side to said circuit board and the other end catching on said ring member, and said spring member deforms when said carriage module moves in a direction contrary to said specific direction for stretching said flat flexible cable and recovers to pull said ring member when said carriage module moves in a direction conforming to said specific direction for stretching said flat flexible cable.

19. The flatbed image scanner according to claim 18 wherein said cable-adjusting device further comprises a rope connecting said spring member to said ring member.

20. The flatbed image scanner according to claim 14 wherein said cable-adjusting device further comprises:
a rope with one end connected to said ring member; and
an automatic reel fixed to said casing at the opposite side to said circuit board and coupled to said rope, wherein said automatic reel reels off said rope to have said ring member move when said carriage module moves in a direction contrary to said specific direction for stretching said flat flexible cable and reels in said rope to pull said ring member when said carriage module moves in a direction conforming to said specific direction for stretching said flat flexible cable.
